(19) United States
(12) Patent Application Publication
(10) Pub. No.: US 2018/0281488 A1
(43) Pub. Date: Oct. 4, 2018

(54) TAPE COATING APPARATUS AND PRINTING APPARATUS

(71) Applicant: DOVER EUROPE SARL, Vemier (CH)

(72) Inventors: Simon Starkey, Leicestershire (GB); Mohammed Toudmeri, Birmingham, West Midlands (GB)

(73) Assignee: Dover Europe Sarl, Vemier (CH)

(21) Appl. No.: 15/765,708

(22) PCT Filed: Oct. 6, 2016
(86) PCT No.: PCT/EP16/73847

§ 371 Date: Apr. 3, 2018

(30) Foreign Application Priority Data
Oct. 6, 2015 (GB) 1517636.5

(51) Int. Cl. B41J 31/16; B41J 2/33; B41J 35/36; B41J 2/005

(52) U.S. Cl. CPC B41J 31/16; B41J 2/0057; B41J 35/36; B41J 2/33

(57) ABSTRACT

A tape coating apparatus (155) including a slot die (163) to apply ink to a printer tape (105), a printing apparatus (100) including such a tape coating apparatus (155) and a method of applying ink to a tape (105) using a slot die (163).

### DESCRIPTION OF INVENTION

The present invention relates to a coating apparatus for applying ink to a printer tape, a printing apparatus including such a coating apparatus and a method of applying ink to a printer tape.

The invention is particularly useful in relation to a printing apparatus which utilises a printing tape or “ribbon” which includes a web carrying marking medium, e.g. ink, and a printhead which, in use, removes marking medium from selected areas of the web to transfer the marking medium to a substrate to form an image, such as a picture or text.

More particularly, the invention relates to a so called thermal transfer overprinting apparatus in which the printhead includes a plurality of thermal heating elements which are selectively energisable by a controller during printing to warm and soften pixels of ink from the tape and to transfer such pixels to the substrate. The printhead presses the tape against the substrate such that the pixels of ink contact the substrate before the web of the tape is peeled away, thus transferring the pixels of ink from the tape to the substrate.

A thermal transfer overprinter may be used to print on to a product's primary packaging and typically mounts within a packaging machine. The image to be printed is often a date code or other product information which needs to be applied to the product's packaging as close as possible to the time at which the product was packaged. A tape drive is used to move and position the thermal transfer tape.

It is known to provide thermal transfer printing apparatus in two different configurations. In the first, so called “intermittent” configuration, the substrate to be printed and the tape are held stationary during a printing operation, whilst the printhead is moved across the area of the substrate to be printed. Once the printing operation is complete, the printhead is lifted away from the tape, and the tape is advanced to present a fresh region of tape to the printhead for the next printing operation.

In the second, so called “continuous” configuration, the substrate to be printed moves substantially continuously and the tape is accelerated to match the speed of the tape before the printhead is brought into thermal contact with the tape and the printing operation is carried out. In this configuration, the printhead is maintained generally stationary during each printing operation.

In the case of a printing apparatus in continuous configuration, it is also necessary to accurately control the speed of the tape, to ensure that it matches the speed of the substrate. A typical thermal transfer printer operates with substrate that advances at linear speeds between approximately 0.01 metres per second and approximately 2 metres per second. Typical substrate accelerations are up to approximately 12 metres per second per second.

Printing apparatus of the kind described above includes drive apparatus for moving the tape relative to the printhead, to present fresh tape, from which pixels of ink are yet to be removed, to the printhead, such that successive printing operations can be carried out. It has long been known to provide tape drives which include two spool supports, one of which supports a supply spool on which unused tape is initially wound, and the other of which supports a take-up spool, onto which the tape is wound after it has been used. Tape extends between the spools in a tape path. Each of the spool supports, and hence each of the spools of tape, is drivable by a respective motor.

It is also known, for example from U.S. Pat. No. 8,922,611, to provide a printing apparatus which includes a substantially continuous band or loop of tape or ribbon, upon which is provided hot-melt ink. A thermal transfer printhead is positioned adjacent the band, so that during a printing operation, the printhead is operable to transfer ‘pixels’ of ink on to a substrate, e.g. packaging or a label. The band is moveable in a path such that following the removal of ink from a portion of the tape, the portion of tape from which the ink has been removed is positioned adjacent a heating device, to cause the ink which remains on the band to be melted, to flow and to be redistributed on the band, to replace at least some of the ink which has been removed. It will be appreciated that the movement of the band may be ‘intermittent’ or ‘continuous’ as outlined above. The heating device of this printer also includes an ink roller for applying additional ink to the band, which is used to substantially uniformly coat the band with ink.

The inks required for a thermal transfer print process have very high viscosity (typically greater than approximately 20 Pa s when molten). Melting of the ink typically occurs at temperatures above approximately 90° C. Using a roller mechanism to reapply ink to the band is very difficult to achieve with such high viscosity inks. Controlling the coating process using a roller is very difficult.

An aim of the present invention is to provide an improved apparatus and method of applying ink to a printer tape.

In accordance with a first aspect of the present invention, there is provided a tape coating apparatus including a slot die to apply ink to a printer tape.

The tape coating apparatus may be to apply ink to a thermal transfer printer tape.

The tape coating apparatus may be operable to apply ink to a substantially continuous band of printer tape.

The tape coating apparatus may be operable to apply ink to a printer tape which already bears a quantity of ink.

A controller may be included to control the operation of the slot die, which may include controlling the flow of ink to and/or from the slot die.

The tape coating apparatus may include a pump or reversible pump which may be controlled by the controller.

The controller may be operable to determine the amount of ink which is required to restore an amount of ink on the tape to a desired, substantially uniform thickness across a portion of the tape.

One or more sensors may provide a signal to the controller.

At least one of the one or more sensors may provide a signal to the controller which is indicative of the amount of ink remaining on the tape following a printing operation and/or the amount of ink which is absent from the tape following a printing operation.

At least one of the one or more sensors may be operable to provide a signal to a controller which is indicative of a size of a meniscus of ink which is adjacent an opening of the slot die.

The tape coating apparatus may include an ink removal device which may remove at least a portion of ink which remains on a portion of the tape after a printing operation, from the band.

The ink removal device may be operable to remove substantially all of the ink which remains on a portion of the tape after a printing operation.

The slot die may include a slot defined by first and second side parts, whereby the first side part may be longer than the second side part so as to form an extended lip.

In according with a second aspect of the invention, there is provided a printing apparatus which includes a tape coating apparatus in accordance with the first aspect of the invention.

The printing apparatus may include a printhead which may be operable to transfer ink from a substantially continuous band of inked tape to a substrate, and may include a support apparatus for supporting a band of inked tape which may be adjacent the printhead and the tape coating apparatus.

A drive mechanism may be included for transporting the tape in a loop, such that successive portions of tape may be alternately positioned adjacent the printhead and the tape coating apparatus.

The printing apparatus may be a thermal transfer printer.

In accordance with a third aspect of the present invention, there is provided a method of coating a tape for use in a printing apparatus with ink, the method including applying a portion of ink to the tape using a slot die.

The method of coating a tape may include applying ink to a portion of the tape which already bears a quantity of ink.

The method of coating a tape may include transporting the tape in a loop such that successive portions of tape may be alternately positioned adjacent a printhead of the printing apparatus and the slot die.

The successive portions of tape may be transported in a substantially continuous loop so as to repeatedly be presented alternately to the printhead and the slot die.

The method may include controlling the operation of the slot die by controlling the flow of ink to and/or from the slot die.

The method may include controlling a pump rate of a pump or reversible pump which pumps ink to and/or from the slot die.

The method may include determining the amount of ink which is required to replace ink which has been removed from a portion of the tape in a printing operation, to restore a coating of ink on the tape to a desired, substantially uniform thickness.

The method may include providing a signal to a controller, the signal being indicative of the amount of ink remaining on the portion of the tape following a printing operation and/or indicative of the amount of ink which is absent from the portion of the tape following a printing operation.

The method may include using the signal indicative of the amount of ink remaining on the portion of tape and/or the signal indicative of the amount of ink which is absent from the portion of the tape to control the flow of ink to and/or from the slot die.

The method may include providing a signal to a controller which is indicative of a size of a meniscus of ink which is adjacent an opening of the slot die.

The method may include using the signal which is indicative of the size of the meniscus to control the flow of ink to and/or from the slot die.

The method may include removing at least a portion of ink remaining on a portion of the tape following a printing operation, and before re-coating that portion of the tape with ink.

The method may include removing substantially all of the ink remaining on a portion of the tape following a printing operation and before re-coating that portion of the tape with ink.

The invention will now be described, by way of example only, with reference to the accompanying drawings, of which:

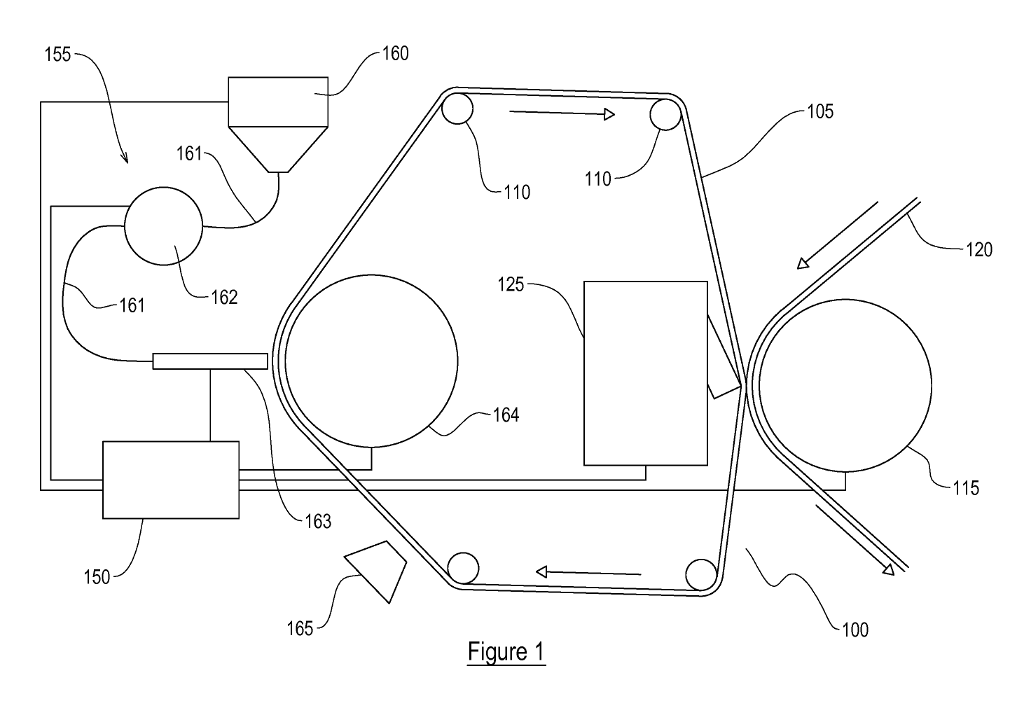

FIG. 1 is an illustrative view of a printing apparatus including a tape coating apparatus;

FIG. 2 is a perspective view of a part of the tape coating apparatus;

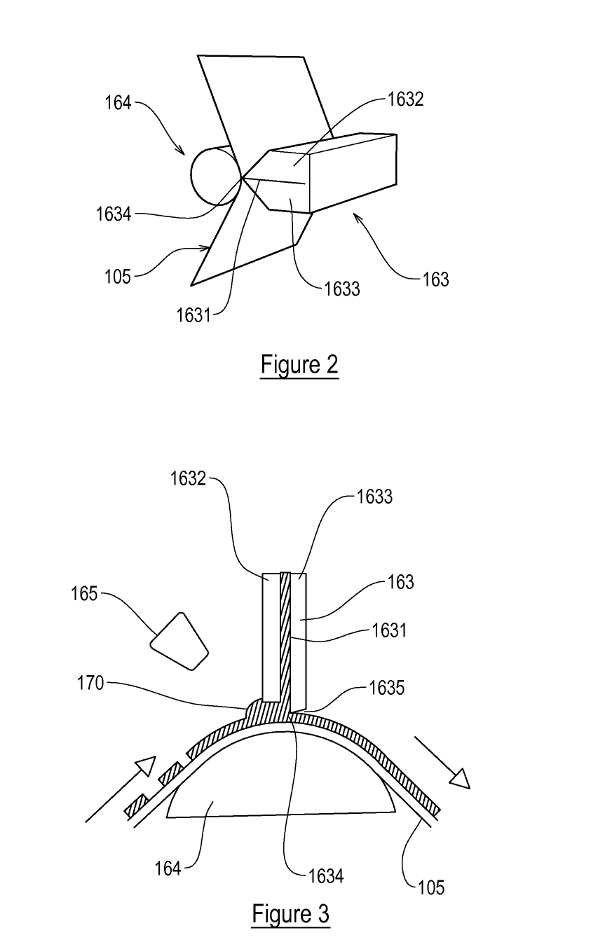

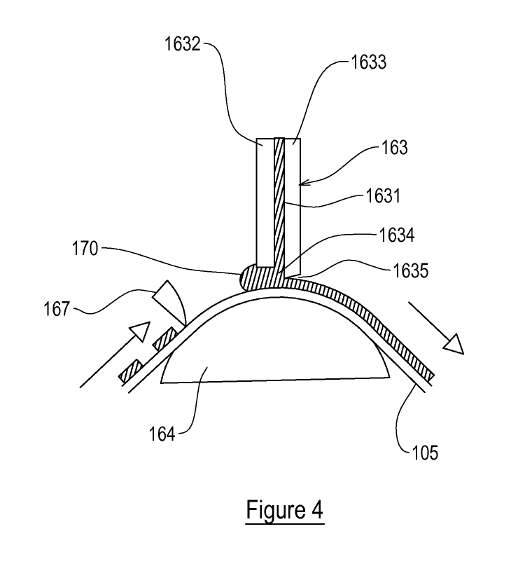

FIG. 3 is a cross sectional view of the coating apparatus applying ink to a band of tape; and

FIG. 4 is a cross sectional view of the tape coating apparatus including an ink removal device.

Referring to FIG. 1, there is shown a printing apparatus 100. The printing apparatus is a thermal transfer printing apparatus. The printing apparatus 100 includes a band of tape 105, which is supported in the printing apparatus 100 by a support apparatus. In the present example, the support apparatus includes a plurality of rollers 110, but it will be appreciated that the support apparatus may include additional or alternative components, for example pins, plates or rods. A part of the support apparatus, for example one or more of the rollers 110 may be biased, for example spring loaded, to control tension in the band 105. The support apparatus also includes a roller 164, which will be described in more detail below. The roller 164 could have a form other than a substantially cylindrical body, for example a platen.

The band 105 may be manufactured from various materials, for example polyimide film, engineering plastics, or metal. Selection of an appropriate thickness for a given type of band material can result in good heat transfer characteristics through the band 105, allowing high quality prints at high speeds, whilst also maintaining the durability of the band 105. One example of a suitable material for the band is a polyimide film with a thickness of approximately 7.5 microns. In some implementations, the polyimide film is a Kapton® material from E. I. du Pont du Nemours and Co. In some implementations, the band 105 may be engineering plastic which has a heat transfer rate of greater than 0.120 Watts/metre-Kelvin and a thickness less than 25 microns, for example 4.5 microns. In some implementations, the band can be a metal, such as stainless steel ribbon with a thickness of 10 microns or less, for example 5 microns. The band 105 is substantially continuous, as in U.S. Pat. No. 8,922,611.

A substrate support 115 is provided to support a substrate 120, for example paper, plastics film, or labels, adjacent the band 105, and a printhead 125. The substrate support 115 is shown as a roller, but could be of any appropriate form, for example a platen. The printhead 125 is a thermal transfer printhead, which includes an array of selectively energisable printing elements for transferring ink from the band 105 to the substrate 120. The printhead 125 includes a mechanism which is operable to press the band 105 against the substrate 120, so that a portion of ink on the band 105, which has been heated by the or each energised printing element of the printhead 125 is transferrable to the substrate 120.

The printing apparatus 100 also includes a tape coating apparatus 155. The tape coating apparatus 155 includes a reservoir or tank 160 for holding hot melt ink. The tape coating apparatus 155 also includes a slot die 163. The tape coating apparatus 155 also includes a pump 162 for transferring ink between the tank 160 and the slot die 163. Different arrangements of the components of the tape coating apparatus 155 are possible to optimise the mechanism for the space available. The tank 160 and pump 162 may be incorporated into the slot die 163 itself, removing the need for the interconnecting pipes 161, for example.

The tank 160 is preferably heatable to a temperature which is suitable to maintain the hot melt ink in liquid or at least semi-liquid form. The tank 160 is fluidly communicable with the slot die 163. The tank 160 is fluidly communicable with the pump 162 via a pipe or pipes 161. The pump 162 is fluidly communicable with the slot die 163 via a pipe or pipes 161. The pump 162 is operable to transfer ink from the tank 160 to the slot die 163. The pump 162 is a reversible pump, to enable the pump 162 to transfer ink back to the tank 160, but may be of an alternative type, as necessary or appropriate. For instance, in some embodiments, there may be more than one, e.g. two, pumps whereby a first pump is configured to transfer ink to the slot die 163 and a second pump is configured to transfer ink away from the slot die 163.

The or each pipe 161 is preferably heatable, to maintain ink in liquid form as it is transferred from the tank 160 to the slot die 163. The slot die 163 and the roller 164 are also preferably heatable. The optimum temperature of ink for a successful coating operation is dependent upon the type of ink and the material of the band 105, and is determined by empirical testing. The temperatures of the tank 160, the or each pipe 161, the slot die 163 and/or the roller 164 are controlled by a controller 150, which is operable to monitor the temperature of each component of the coating apparatus 155, and may also monitor the ambient temperature, to select and/or adjust the temperature of one or more of the components of the tape coating apparatus 155. A temperature of one or more of the components of the coating apparatus 155 may additionally be selectable and/or adjustable by an operator.

FIGS. 2 and 3 show the slot die 163 in more detail. The slot die 163 includes a slot 1631 defined by two side parts 1632, 1633. The slot 1631 terminates in an opening 1634 which is positioned near to and facing the roller 164. In some embodiments, the slot die 163 may include an extended lip 1635, which is formed by the side part 1633 being slightly longer than the side part 1632. One purpose of the extended lip 1635 may be, for example, to assist in controlling the thickness of the coating of ink applied to the band 105.

The controller 150 is part of a control system which controls the process of coating the band 105 with ink. In the present example, the controller 150 also controls the speed and direction of travel of the band 105, by controlling the operation of a band drive mechanism. However, it will be appreciated that, additionally or alternatively, the controller 150 may receive a signal from a sensor or the like, which indicates the speed and/or direction of travel of the band 105. The controller 150 is able to stop movement of the band 105. The speed and direction of the substrate 120 is typically controlled by a packaging machine with which the printing apparatus 100 is associated. The controller 150 is operable to control the printhead 125, for example to energise printing elements of the printhead 125 to create an image, and to move the printhead 125 into and out of engagement with the band 105. It is important that the speed and direction of the band 105 matches that of the substrate 120 whenever the printhead 125 is engaged with the substrate 120.

The control system may include a sensor 165 which is, for example, an optical sensor or an ultrasonic sensor. In some embodiments, the sensor 165 may be operable to ‘scan’ the band 105 in a location near to the coating apparatus 155 to determine the amount of ink on the band 105. In some embodiments, the sensor 165 may be operable to determine the size of a meniscus of ink adjacent the opening 1634 of the slot die 163.

In use, the controller 150 controls the printing apparatus 100 to carry out printing operations. Each printing operation may include a printing phase during which ink is transferred from the band 105 to the substrate 120 and a non-printing phase during which ink is not transferred from the band 105 to the substrate 120. The movement of the band 105 and the substrate 120 during each printing operation are controlled by the controller 150. The speed and direction of the band 105 and/or the substrate 120 may alter during the course of each printing operation. A series of printing operations may be carried out sequentially, and substantially continuously.

The controller 150 operates the printhead 125 to move the printhead 125 directly adjacent the band 105, and selectively energise one or more of the printing elements of the printhead 125, such that the or each energised printing element is able to melt a portion of ink on the band, and transfer the melted ink to the substrate 120. Once the printing operation is complete, the controller 150 de-activates the or each printing element and/or retracts the printhead 125 from the band 105.

The band 105 travels in a substantially continuous loop such that after each successive portion of the band 105 has been used in a printing operation, that portion of the band 105 moves towards the slot die coater 163, to replace the ink which has been removed in the printing operation.

The band 105 is, in part, supported by the roller 164, which is substantially adjacent the slot die 163. The controller 150 controls the temperature of the roller 164 so as to melt or at least soften the remaining ink on the band 105 before it reaches the slot die 163. As mentioned above, the appropriate optimum temperature will depend upon the material of the band 105 and the type of ink.

The slot die 163 is then used to apply ink to the band 105, to provide a substantially uniform coating of ink of a desired thickness on the band 105. The desired thickness of the ink ‘film’ which is applied to the band is between approximately 4 μm and approximately 20 μm.

The controller 150 is operable to control the speed of the pump 162, which in turn affects the volume of the ink leaving the slot die 163 and hence the thickness of the coating of ink applied to the band 105. The controller 150 is able to use a number of variables to determine the speed of the pump 162, which variables may include the speed of the band 105 and/or the amount of ink remaining on the band after a printing operation and before a coating operation. When the band 105 is moving, it is advantageous for the speed of the pump 162 to be directly proportional to the speed of travel of the band 105.

It is advantageous for the speed of the pump to be inversely proportional to the amount of ink remaining on the band 105. The amount of ink remaining on the band 105 may be determined in two ways, in order to control the slot die 163 in an appropriate manner. The two methods may be used alone or in conjunction with one another.

In the first method, each successive portion of the band 105 is scanned by the sensor 165 as it returns towards the coating apparatus 155. For example, an optical or ultrasound scan of the band 105 may be carried out to ascertain the amount of ink remaining on each portion of the band 105 after a printing operation. Other sensing/scanning methods may be desirable and appropriate.

The sensor scans a narrow strip across the band 105, the strip being oriented in a direction which is substantially perpendicular to the direction of travel of the band 105 relative to the printhead and/or the slot die 163.

The controller 150 may assume that the coating of ink is either at the initial, coated thickness, or has been completely removed.

The sensor 165 provides a signal to the controller 150, which is indicative of the amount of ink which has been removed from the band 105 or the amount of ink remaining on the band 105, and hence the amount of ink which is required to be provided by the slot die 163 to restore a required thickness of ink across the full width of the band 105, in a substantially uniform coating. The controller 150 uses this indication, together with knowledge of the movement of the band 105, e.g. speed of movement of the band 105, to control the pump 162, so that the flow of ink from the slot die 163 matches a volume calculated to restore the ink to the scanned strip of the band 105 to its desired, substantially uniform thickness, when the strip arrives at a position adjacent the slot die 163. The controller 150 has knowledge of the linear distance between the band 105 and the opening 1634 of the slot die 163.

In a second method of operation, the controller 150 controls the speed of the pump 162, which controls the flow of ink in to the slot die 163. A meniscus 170 is formed at the opening 1634 of the slot die 163 (i.e. at the end closest to the band 105). The size of the meniscus 170 is dependent on a number of variables, for example, the speed of the pump 162, the amount of ink being ‘taken’ by the band 105 as it travels past the slot die 163, the viscosity of the ink being used, etc. The controller 150 monitors the size of the meniscus 170 using the sensor 165. The controller 150 controls the pump 162 to maintain the meniscus 170 at or substantially at an optimum size. For example, if the controller 150 detects that the size of the meniscus 170 is decreasing, this may mean that more ink is being used to restore ink on the band 105 than is being pumped into the slot die 163. Thus, the controller 150 may increase the speed of the pump 162 to restore the meniscus 170 to a pre-determined/optimum size. Likewise, if the controller 150 detects an increase in the size of the meniscus 170, this may indicate that less ink is being used to coat the band 105 than is being pumped in to the slot die 163. In other words, the band 105 may be close to saturation. Thus, the controller 150 may reduce the speed of the pump 162 (or stop the pump 162 altogether) to restore the meniscus 170 to the predetermined size.

In other words, the amount of ink left on the band 105 after a printing operation will affect how much ink is laid down by the slot die 163 (from the meniscus 170). If a lot of ink has been removed during the printing operation comparatively more ink will be taken from the meniscus to “fill in the gaps” on the band 105, and vice versa, if less ink has been removed from the band 105 then less ink will be needed from the meniscus 170 to restore the coating on the band 105.

The signal sent to the controller 150 which is indicative of the size of the meniscus 170 is used to control the speed of the pump 162. Therefore, monitoring the size of the meniscus 170 ensures that a uniform thickness of ink is restored to the band 105.

In some embodiments, the sensor 165 may send signals to the controller 150 substantially continuously during operation of the printing apparatus 100 or at predetermined time intervals. Therefore, any of the methods of operation described above may result in an iterative process. In some embodiments, the controller 150 may continuously update one or more control parameters (for example, the speed of the pump 162) of the slot die 163 based on signals received from the sensor 165.

In some embodiments, the resilience of the roller 164 may be set based upon the properties of the ink (including viscosity) and the thickness of the coating of ink which is required. Standard coating applications are available to calculate the required resilience.

In some embodiments (which may be in combination with the above described methods or alone), the extended lip 1635 may control the thickness of the coating of ink on the band 105, as the band is coated by the slot die 163. The ink on a portion of the band 105 has been ‘fragmented’ by a printing process, and the portion of the band 105 is returned to the slot die 163 to be coated with ink. The remaining ink on the band 105 is melted or at least softened by the roller 164 as the portion of the band 105 nears the slot die 163. The melted remaining ink is combined with replacement ink which is provided by the slot die 163. The thickness of the ink layer leaving the slot die 163 is controlled by a combination of the position of the extended lip 1635 relative to the roller 164, the thickness of the band 105, and the resilience of the roller 164.

The controller 150 may use information relating to images printed by the printing apparatus 100 to determine the amount of ink required to replace the ink which has been removed from the tape in a printing operation. The controller 150 has knowledge of how many printing elements of the printhead 125 are/have been activated during a printing operation, or during a series of printing operations, and their position relative to the band 105. The controller 150 can assume that activation of each printing element leads to transfer of ink to the substrate 120. Since the controller 150 also controls the movement of the band 105, the controller 150 can determine when a depleted area of ink has arrived or is due to arrive at the slot die 163. This information can be used alone, or to validate the information received from the sensor 165, to determine the amount of ink which remains on the band 105, and how much ink should be applied by the slot die 163. The controller 150 is able to operate the coating apparatus 155 accordingly, to apply the correct amount of ink to achieve a uniform, optimum thickness coating on the band 105.

Once each portion of the band 105 has been coated, it then returns towards to printhead 125 to be used in a subsequent printing operation. As each portion of the band 105 moves away from the slot die 163, and leaves the vicinity of the roller 164, the coating of ink on the band is able to cool and solidify, before it reaches the printhead 125.

This printing and recoating process repeats substantially continuously, although it will be appreciated that the band 105 need not, and in practice is unlikely to, move at a constant speed. In other words, whilst the printing and recoating process is substantially continuous, there may be pauses, and the band 105 may even reverse direction, to take into account requirements of each printing operation or a particular printing operation.

In the event that the controller 150 detects that the speed of the substrate 120 has reduced so much that it is not possible for a printing operation to be successfully carried out, for example the speed of the substrate 120 has reduced to approximately 50 mm/s or less, the printing activity may be aborted. When printing operations are to cease, the controller 150 controls the printhead 125 to cease printing, by de-energising any currently energised printing elements and not energising any further printing elements of the printhead 125 and/or retracting the printhead 125, or at least a part thereof, away from the band 105. The controller 150 also reduces the speed of the band 105 to its minimum speed, which may be stationary. As the band 105 slows to a stop, the controller 150 controls the pump 162 to reverse the flow of ink, back towards the tank 160, to prevent a build-up of ink between the slot die 163 and the band 105, which can solidify and form lumps on the band 105 and/or on or in the opening of the slot die 163.

In an embodiment of the invention, as shown in FIG. 4, the printing apparatus includes an ink removal device 167. The ink removal device 167 is positioned near to the slot die 163, and is operable to remove as much ink as possible, preferably all of the ink, which remains on a portion of the band after a printing operation has been carried out. The ink removal device 167 may be a rigid or resilient blade, which is operable to scrape ink from the surface of the band 105, as the band travels between the printhead 125 and the slot die 163. The slot die 167 then replaces a uniform coating of ink on the band 105 before a further printing operation is carried out. This is a substantially continuous process, such that as ink is being removed from one portion of the tape in a printing operation, the remaining ink is being removed from a further portion of the band 105, and replacement ink is being applied to yet another portion of the band 105 by the slot die 163. An advantage of this embodiment of the printing apparatus 100 is that it is not strictly necessary to determine the amount of ink left on each portion of the band 105 before it reaches the slot die 163, since substantially all of the ink has been removed from the band 105. Therefore the slot die is operable in accordance with the speed of the band to apply a desired thickness of ink to each successive portion of the band 105. It will be understood that the methods of determining the amount of ink remaining on each successive portion of the band 105 may still be used, to check that the portion of the band which is about to be coated with ink by the slot die 163 is, in fact, free or substantially free from ink. This avoids inadvertently providing a portion of the band 105 with too thick a coating of ink or a ‘lumpy’ coating of ink.

An advantage of using a slot die as part of the tape coating apparatus 155 is that the thickness of the coating of ink on the band 105 can be controlled by the operation of the pump 162, which can be calibrated to deliver the desired ink thickness on the ‘clean’, i.e. ink free or ‘ink-light’ areas of the band 105. Previously, slot dies have not been used to deliver high viscosity inks. Furthermore, in conventional slot die applications, the carrier material (in this example, the band 105) to which a substance (in this example, ink) is applied, is completely clean, i.e. it does not carry any of the substance prior to the slot die application process. The present invention overcomes the difficulty of providing the band with a substantially uniform coating thickness even when applying high viscosity ink to a band which already bears some ink.

The invention has been described in relation to hot melt inks, but it will be appreciated that other types of ink may be applied to a tape using the apparatus and method described herein.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A tape coating apparatus including a slot die to apply ink to a printer tape.

2. A tape coating apparatus according to claim 1 to apply ink to a thermal transfer printer tape.

3. A tape coating apparatus according to claim 1 or claim 2 which is operable to apply ink to a substantially continuous band of printer tape.

4. A tape coating apparatus according to any of the preceding claims which is operable to apply ink to a printer tape which already bears a quantity of ink.

5. A tape coating apparatus according to any of the preceding claims which includes a controller to control the operation of the slot die, including by controlling the flow of ink to and/or from the slot die.

6. A tape coating apparatus according to claim 5 which further includes a pump or reversible pump which is controlled by the controller.

7. A tape coating apparatus according to claim 5 or 6 wherein the controller is operable to determine the amount of ink which is required to restore an amount of ink on the tape to a desired, substantially uniform thickness across a portion of the tape.

8. A tape coating apparatus according to claim 5 or 6 or 7 including one or more sensors to provide a signal to the controller.

9. A tape coating apparatus according to claims 8 wherein at least one of the one or more sensors provides a signal to the controller which is indicative of the amount of ink remaining on the tape following a printing operation and/or the amount of ink which is absent from the tape following a printing operation.

10. A tape coating apparatus according to any of claim 8 or 9 wherein at least one of the one or more sensors is operable to provide a signal to a controller which is indicative of a size of a meniscus of ink which is adjacent an opening of the slot die.

11. A tape coating apparatus according to any of the preceding claims, including an ink removal device to remove at least a portion of ink which remains on a portion of the tape after a printing operation, from the band.

12. A tape coating apparatus according to claim 11 wherein the ink removal device is operable to remove substantially all of the ink which remains on a portion of the tape after a printing operation.

13. A tape coating apparatus according to any of the preceding claims wherein the slot die includes a slot defined by first and second side parts, whereby the first side part is longer than the second side part so as to form an extended lip.

14. A tape coating apparatus substantially as described herein and/or as shown in the accompanying drawings.

15. A printing apparatus including a tape coating apparatus according to any of claims 1 to 14.

16. A printing apparatus according to claim 15, the printing apparatus including a printhead which is operable to transfer ink from a substantially continuous band of inked tape to a substrate, and a support apparatus for supporting a band of inked tape adjacent the printhead and the tape coating apparatus.

17. A printing apparatus according to claim 16, including a drive mechanism for transporting the tape in a loop, such that successive portions of tape are alternately positioned adjacent the printhead and the tape coating apparatus.

18. A printing apparatus according to claim any of claims 15 to 17 wherein the printing apparatus is a thermal transfer printer.

19. A printing apparatus substantially as described herein and/or as shown in the accompanying drawings.

20. A method of coating a tape for use in a printing apparatus with ink, the method including applying a portion of ink to the tape using a slot die.

21. A method of coating a tape according to claim 20 including applying ink to a portion of the tape which already bears a quantity of ink.

22. A method of coating a tape according to claim 20 or claim 21 including transporting the tape in a loop such that successive portions of tape are alternately positioned adjacent a printhead of the printing apparatus and the slot die.

23. A method of coating a tape according to claim 22, wherein the successive portions of tape are transported in a substantially continuous loop so as to repeatedly be presented alternately to the printhead and the slot die.

24. A method of coating a tape according to any of claims 20 to 23 which includes controlling the operation of the slot die by controlling the flow of ink to and/or from the slot die.

25. A method of coating a tape according to claim 24 including controlling a pump rate of a pump or reversible pump which pumps ink to and/or from the slot die.

26. A method of coating a tape according to claim 24 or 25 including determining the amount of ink which is required to replace ink which has been removed from a portion of the tape in a printing operation, to restore a coating of ink on the tape to a desired, substantially uniform thickness.

27. A method of coating a tape according any of claims 24 to 26 including providing a signal to a controller, the signal being indicative of the amount of ink remaining on the portion of the tape following a printing operation and/or indicative of the amount of ink which is absent from the portion of the tape following a printing operation.

28. A method of coating a tape according to claim 27 including using the signal indicative of the amount of ink remaining on the portion of tape and/or the signal indicative of the amount of ink which is absent from the portion of the tape to control the flow of ink to and/or from the slot die.

29. A method of coating a tape according to claim 24 to claim 28 including providing a signal to a controller which is indicative of a size of a meniscus of ink which is adjacent an opening of the slot die.

30. A method of coating a tape according to claim 29 including using the signal which is indicative of the size of the meniscus to control the flow of ink to and/or from the slot die.

31. A method according to any one of claims 20 to 30 including removing at least a portion of ink remaining on a portion of the tape following a printing operation, and before re-coating that portion of the tape with ink.

32. A method according to claim 31 including removing substantially all of the ink remaining on a portion of the tape following a printing operation and before re-coating that portion of the tape with ink.

33. A method of coating a tape for use in a printing apparatus with ink substantially as described herein and/or as shown in the accompanying drawings.

34. Any novel feature or novel combination of features substantially as described herein and/or as shown in the accompanying drawings.
